(19) United States
(12) Patent Application Publication
(10) Pub. No.: US 2008/0170143 A1
(43) Pub. Date: Jul. 17, 2008

(54) SOLID-STATE IMAGING DEVICE AND CAMERA USING THE SAME

(75) Inventor: Shinji YOSHIDA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/970,235

(22) Filed: Jan. 7, 2008

(30) Foreign Application Priority Data
Jan. 16, 2007 (JP) 2007-006656

(51) Int. Cl. H04N 5/335

(52) U.S. Cl. 348/294; 348/E05.091

(57) ABSTRACT

The object of the present invention is to provide a solid-state imaging device equipped with a color filter which is highly durable, inexpensive to manufacture, and adaptable to the scaling down of pixels, and a camera using the solid-state imaging device. The solid-state imaging device includes a photodiode, and a metal optical filter formed above the photodiode, which allows light of a desired wavelength to be transmitted. The metal optical filter is made of a metal thin film in which plural cylinder-shaped apertures are periodically arrayed. The size of each of the apertures is smaller than the desired wavelength, and an inter-aperture distance between a predetermined aperture and an aperture adjacent to the predetermined aperture is shorter than the desired wavelength.

### BACKGROUND OF THE INVENTION

(1) Field of the Invention

The present invention relates to a solid-state imaging device equipped with a filter which cuts off light of an unnecessary wavelength within a wavelength band in which a photodiode is sensitive. The present invention also relates to a method for manufacturing the solid-state imaging device and a digital camera using the solid-state imaging device, or the like.

(2) Description of the Related Art

Conventionally, a multiple-chip system and a single-chip system have been known as color separation techniques for the solid-state imaging device. In the multiple-chip system, color separation is performed on an image using a color separation prism, and the color-separated image is converted into an electric signal by three or four solid-state imaging devices, and color signals are obtained. On the other hand, in the single-chip system, color separation is performed on an image using on-chip color filters in three or four colors that are formed in the solid-state imaging device, and the color-separated image is converted into electric signals by a single solid-state imaging device. Furthermore, the single-chip system is divided into a primary color system and a complementary color system in accordance with the color when color separation is performed. For example, in the primary color system, pixels are sorted into three colors, that is, red (R), green (G), and blue (B). In the complementary color system, the pixels are separated into four colors, that is, cyan (Cy), magenta (Mg), yellow (Ye), and green (G) (For example, see page 183, “Kotai Satsuzo Soshi no Kiso” (Basics of Solid-state Imaging Devices).

FIG. 1 shows an example of a conventional solid-state imaging device.

This solid-state imaging device includes: an image area 104 that is made of plural unit pixels 120 arrayed in a matrix; a row selecting circuit 110 which selects unit pixels 120 on a per-row basis; a first vertical signal line 109 which transmits the signal voltage of the unit pixel 120 to a signal processing unit 111, on a per-column basis; the signal processing unit 111 which holds the signal voltage transmitted via the first vertical signal line 109 and cuts off high-frequency noise; a column selecting circuit 112 which selects the unit pixel 120 on a per-column basis; a horizontal signal line 113 which transmits the signal voltage outputted by the signal processing unit 111 to an output amplifier 114; the output amplifier 114; and a load transistor group 115.

The image area 104 includes: a photodiode 121, a readout transistor 122, a reset transistor 123, an amplification transistor 124, a vertical selection transistor 126, and a floating diffusion unit (hereinafter, referred to as an FD unit) 125 that is directly connected to a gate of the amplification transistor 124.

In this structure, an on-chip color filter is provided for each unit pixel 120, and each unit pixel 120 performs photoelectric conversion only on light signals within a wavelength band selected by the color filters. In this manner, the color signals can be obtained with respect to each unit pixel 120, and a color image can be obtained by compositing such color signals.

FIG. 2 is a cross-sectional view of the unit pixel 120 in a conventional solid-state imaging device.

In the conventional solid-sate imaging device, at least one layer of wiring 14 is provided above the photodiode 121 and the readout transistor 122 for obtaining electric signals from the photodiode 121, with an interlayer film 13 being sandwiched in between. Furthermore, a pigment-type color filter 15 and a microlens 16 are provided above the wiring 14, with an insulation film being sandwiched. In this unit pixel 120, the light that is collected by the microlens 16 provided above the color filter 15 is transmitted through the color filter 15 and is separated, in accordance with the wavelength selectivity of the color filter 15, into lights of respective wavelength bands, that is, R (red), G (green), and B (blue), thus allowing color separation.

### SUMMARY OF THE INVENTION

Meanwhile, in the unit pixel as shown in FIG. 2, the film thickness of the color filter is as large as 1 μm or more in order to realize high wavelength sensitivity (color resolution). Therefore, along with the scaling down of pixels in recent years, the light transmitted through the microlens invades an adjacent pixel due to the large thickness of the color filter. For example, color mixing occurs in which the color of G or B is mixed into the color of R, causing deterioration in the color separation function. As a result, a color filter which can suppress sensitivity decline and color unevenness resulting from the scaling down of pixels is anticipated. In other words, the color filter which can realize a solid-state imaging device of higher picture quality is anticipated.

In addition, in the forming of on-chip color filters, forming processes using photo masks are required for each of the colors. Therefore, in order to form three types of color filters R, G, and B, for example, three types of photo masks are needed. Therefore, such conventional on-chip color filters become a factor for raising manufacturing costs for the solid-state imaging device. As a result, an on-chip color filter which can reduce costs by shortening the manufacturing time and improve the yield is desired.

Furthermore, since conventional color filters are made of pigments, color-tone changes, such as the color-fading of the pigments, occur over time under high temperature conditions, such as in the open air. Therefore, conventional color filters have great problems in their reliability.

Therefore, the present invention is conceived in view of the above problems and has as an object to provide a solid-state imaging device equipped with an optical filter that is highly durable, inexpensive to manufacture, and adaptable to the scaling down of pixels, and a camera using the solid-state imaging device.

In order to achieve the object, the solid-state imaging device according to the present invention is a solid-state imaging device which includes a plurality of photodiodes and a plurality of metal optical filters each formed above a corresponding one of the plurality of photodiodes, and which allows light of a desired wavelength to be transmitted, and each of the plurality of metal optical filters is made of a metal film in which plural apertures are periodically arrayed.

With this structure, surface plasmons are induced within the metal film through the periodically arrayed apertures, in accordance with the incidence of light, thus allowing only specific wavelengths to pass through the metal film. Thus, since a spectral color filter can be realized by using only a single metal film, it is possible to realize an optical filter which enables the reduction of the number of manufacturing processes, the shortening of the manufacturing time length, and the lowering of manufacturing costs. Furthermore, since it is possible to make the film thinner and realize an optical filter which can respond to the scaling down of pixels while suppressing sensitivity degradation and color unevenness, high-definition processing of images can be realized. In addition, since no color-tone changing, as in a conventional pigment-type color filter, occurs, and highly durable optical filter can be realized.

In addition, it is preferable that the plurality of photodiodes is arrayed two-dimensionally, and that the plurality of metal optical filters is arrayed two-dimensionally, each corresponding to one of the plurality of photodiodes. Specifically, it is preferable that a photodiode is provided with respect to each pixel which is a minimum unit comprising an imaging plane, that the metal optical filter is formed above each photodiode, and that the aperture part should be provided in the upper part of the pixel on a pixel-to-pixel basis.

With this structure, it is possible to obtain a different color signal with each pixel since each pixel is provided with a metal optical filter which transmits light of a desired wavelength band. Thus, a solid-state imaging device which allows the obtainment of high-definition color pictures can be realized.

In addition, it is preferable that each of the plural apertures in each of the plurality of metal optical filters is cylinder-shaped.

With this structure, since polarized light in all directions can be treated by forming the apertures in a cylindrical shape, it is possible to improve the light shielding effect and spectral transmission properties of the metal optical filter and obtain higher-definition color images.

In addition, it is preferable that the surface of each of the plurality of metal optical filters is coated with dielectric material, and that the interior of each of the apertures in each of the plurality of metal optical filters should be coated or filled with the dielectric material.

With this structure, since the interior of the aperture is filled with dielectric material, light transmission efficiency is improved, and higher-definition color images can be obtained.

In addition, it is preferable that the distance between a predetermined one of the apertures and an aperture adjacent to the predetermined one of the apertures is shorter than the desired wavelength.

With this structure, an excitation wavelength for the excitation of surface plasmons within the metal thin film is specified according to an inter-aperture distance between apertures provided on the metal film surface and the periodicity of the apertures. Furthermore, transmitted light is also determined by the size of the apertures. Therefore, by adopting an inter-aperture distance and aperture size conforming to the desired transmitted wavelength band, it becomes possible to perform arbitrary color separation, and a wider variety of color images can be obtained.

In addition, it is preferable that the size of a predetermined one of the apertures is smaller than the desired wavelength, and that the distance between the predetermined one of the apertures and an aperture adjacent to the predetermined one of the apertures is shorter than the desired wavelength.

With this structure, by determining the aperture size according to the cutoff wavelength of light, color resolution can be improved, and high-definition color images can be obtained.

In addition, it is preferable that the metal film is made of silver (Ag), platinum (Pt), or gold (Au).

With this structure, since the attenuation of surface plasmon exciters generated inside the metal thin film is small in precious metals as compared to other metals, the transmissivity of light through plasmon resonance increases, color separation level improves, and higher-definition color images can be obtained. In particular, since Ag excels in transmissivity, it is preferable that Ag is used.

In addition, it is preferable that the solid-state imaging device includes a dielectric film formed between each of the plurality of photodiodes and a corresponding one of the plurality of metal optical filters, and having a flat surface on which the metal optical filter is formed.

With this structure, since the metal film is formed on the planarized dielectric material, it is possible to achieve more minute apertures and a shorter inter-aperture distance in terms of an aperture formation process based on lithography. Thus, it becomes possible to realize an optical filter which functions in a wider range of wavelengths.

In addition, it is preferable that the solid-state imaging device also includes a metal wiring made of the same material as the material of which the metal film is made.

With this structure, since the metal film is made of the same material as the metal wiring, it is possible to facilitate a manufacturing process which enables the manufacturing of optical filters at low costs.

Furthermore, it is preferable that the plurality of metal optical filters is formed in the same process as the process in which the metal wiring is formed.

With this structure, by performing the forming of the apertures collectively, at the same time with the forming of the metal wiring, it is possible to achieve process simplification and low-cost manufacturing.

Here, since the metal wiring forming process and the metal optical filter forming process are performed in the same collective process, it is preferable that the metal wiring and the metal film are made of the same material.

In addition, it is preferable that the width of each of the apertures tapers, from a surface of each of the plurality of metal optical filters at which light enters, toward the surface of a corresponding one of the plurality of photodiodes.

With this structure, since plural cutoff wavelengths can be established by forming the apertures in a tapered shape, the cutoff resolution for wavelengths decreases, and the band of transmitted wavelengths can be expanded. Thus, it becomes possible to provide images of high-sensitivity and little color unevenness.

Furthermore, it is preferable that the film thickness of the metal film is 1000 nm or less.

With this structure, since the efficiency of light transmission through surface plasmon resonance increases, it is possible to provide a highly-sensitive solid-state imaging device with a high level of color separation.

It is preferable that in the metal optical filter, a slit is formed as each of the apertures.

With this structure, since the dielectric response of light differs between the short-side direction and the long-side direction of the slit, it becomes possible to perform the separation of polarized light from the transmitted light simultaneously with color separation. Thus, a solid-state imaging device equipped with a spectral polarization element can be realized.

In addition, it is preferable that: the plurality of metal optical filters is made up of a first metal film and a second metal film, the plural apertures being periodically arrayed in both the first and second metal films, and in the first metal film and the second metal film, a slit is formed as each of the plural apertures, and an angle formed by a long-side direction of the slit in the first metal film and a long-side direction of the slit in the second metal film is 90 degrees.

Specifically, it is preferable that: at least two sheets of metal films are provided above the photodiode with an insulating film sandwiched in between, and with slit-like through grooves periodically formed in each of the metal films; the long-side direction of one of the through grooves formed above the first metal film and the long-side direction of one of the through grooves provided in the second metal film are positioned at 90 degrees to each other; and the first metal film and the second metal film are formed above each of the pixels with an insulating film, which is transparent to transmitted light, being sandwiched in between.

With this structure, since the forming of a finer lattice-like aperture becomes possible, it becomes possible to further miniaturize optical filters, and thus a solid-state imaging device, which can capture high-definition and high-quality images, can be realized.

In addition, the present invention can also be realized as a camera equipped with the solid-state imaging device.

With this structure, it is possible to provide not only a low-cost camera which allows capturing of color images, but also a highly durable camera which enables the capturing of high-definition and high-quality color images.

With the solid-state imaging device according to the present invention and the camera equipped with the solid-state imaging device, the optical filter can be made thinner and miniaturized, and an optical filter having a high level of color separation can be realized. At the same time, an optical filter having high durability can be realized. Furthermore, an optical filter, which enables the reduction of the number of manufacturing processes and the shortening of manufacturing time, can be realized. Thus, it becomes possible to provide a more inexpensive solid-state imaging device and camera which allow the capturing of high-definition and high-quality images.

### FURTHER INFORMATION ABOUT TECHNICAL BACKGROUND TO THIS APPLICATION

The disclosure of Japanese Patent Application No. 2007-006656 filed on Jan. 16, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a schematic configuration of a conventional solid-state imaging device;

FIG. 2 is a cross-sectional view showing the structure of the unit pixel in the conventional solid-state imaging device;

FIG. 3A is an electric field strength map showing the behavior of the light having a wavelength of 350 nm which enters through an aperture of 500 nm in diameter according to the first embodiment of the present invention;

FIG. 3B is an electric field strength map showing the behavior of the light having a wavelength of 500 nm which enters through an aperture of 500 nm in diameter according to the embodiment;

FIG. 3C is an electric field strength map showing the behavior of the light having a wavelength of 600 nm which enters through an aperture of 500 nm in diameter according to the embodiment;

FIG. 3D is an electric field strength map showing the behavior of the light having a wavelength of 700 nm which enters through an aperture of 500 nm in diameter according to the embodiment;

FIG. 4 is a perspective view of a metal thin film according to the embodiment;

FIG. 5A is a top view of the metal thin film according to the embodiment;

FIG. 5B is a diagram showing a spectral sensitivity spectrum of the metal thin film according to the embodiment;

FIG. 6 is a top view of a metal optical filter according to the third embodiment of the present invention;

FIG. 7 is a top view of a color filter according to the fifth embodiment of the present invention;

FIG. 8 is a perspective view showing the structure of a solid-state imaging device according to the seventh embodiment of the present invention;

FIG. 9 is a cross-sectional view showing the structure of a deformed example of the solid-state imaging device according to the embodiment;

FIG. 10A is a top view of the metal optical filter according to the eighth embodiment of the present invention;

FIG. 10B is a cross-sectional view (a cross-sectional view at line AA′ in FIG. 10A) of the metal optical filter according to the embodiment;

FIG. 11A is a top view of the metal optical filter according to the ninth embodiment of the present invention;

FIG. 11B is a cross-sectional view showing the structure of the solid-state imaging device according to the embodiment;

FIG. 11C is a perspective view of the first-layer metal thin film and the second-layer metal thin film according to the embodiment;

FIG. 12A is a cross-sectional view of the metal thin film according to the tenth embodiment of the present invention;

FIG. 12B is a cross-sectional view of a deformed example of the metal thin film according to the embodiment;

FIG. 13 is a diagram showing the relationship between the light transmissivity of the metal thin film and the thickness of the metal thin film according to the eleventh embodiment of the present invention; and

FIG. 14 is a block diagram of a digital camera according to the twelfth embodiment of the present invention.

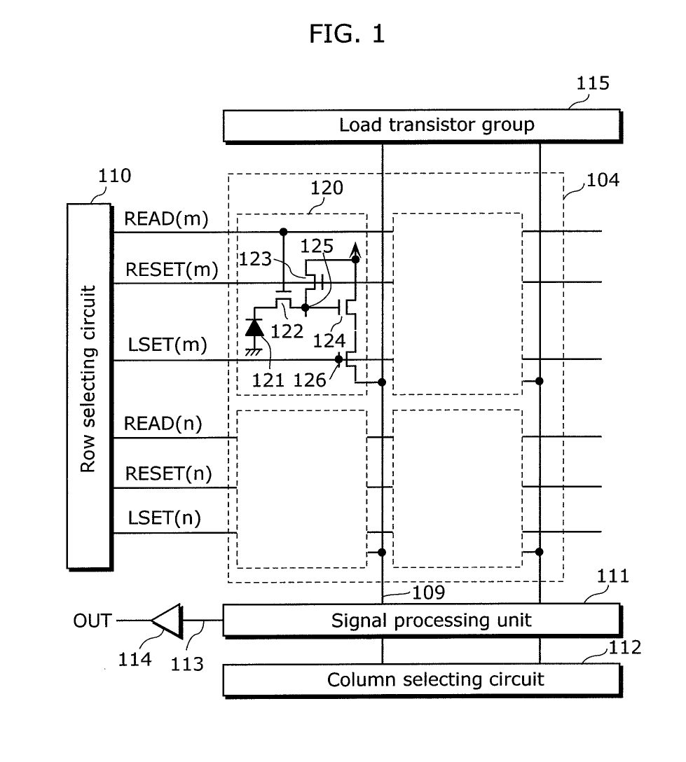

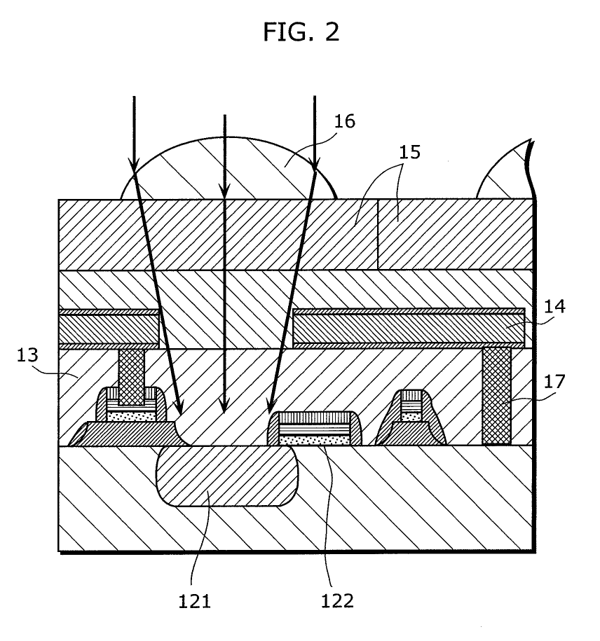

### DESCRIPTION OF THE PREFERRED EMBODIMENT(S)

A solid-state imaging device and a camera according to the embodiments of the present invention shall be described below with reference to the drawings.

### First Embodiment

In the solid-state imaging device according to the present embodiment, a metal optical filter, which allows light of a desired wavelength to be transmitted, is formed above a photodiode (light-receiving element), such as a photodiode, which converts received light into an electric signal, and with an insulating film sandwiched in between the metal optical filter and the photodiode. This metal optical filter is an optical filter made of a metal thin film, and in the metal optical filter, plural apertures are periodically provided in a two-dimensional state. Note that the plural apertures may also be arrayed in a one-dimensional state.

Hereinafter, the behavior of the light with respect to the apertures provided in the metal thin film and periodically arrayed in a two-dimensional state shall be described focusing on a single aperture, and then shall be described focusing on plural apertures that are periodically arrayed. Note that the apertures in the metal thin film are recessed parts or through-holes that are formed in the metal thin film.

The behavior of light with respect to the apertures formed in a good conductor shall be described using a waveguide model. Here, light refers to a microwave according to Maxwell's equations. A waveguide is a hollow pipe with a wall surface made of a good conductor such as metal, and classified into a rectangular waveguide, a circular waveguide, and so on, according to the cross-sectional shape. Note that a property generally known for the waveguide is that a cutoff frequency is specified by the structural dimension of the cross-section of the waveguide, or more specifically, the diameter of the aperture in the waveguide, and that light of frequencies equal to or lower than the specified frequency cannot propagate in the waveguide. This phenomenon is mainly applied to the transmission of microwaves within a microwave band but is also applicable to the transmission of microwaves within a frequency range in which the photodiode has light-receiving sensitivity. A microwave reaching the waveguide is separated into two types of standing waves: a standing wave in the waveguide direction and a standing wave in a direction perpendicular to the waveguide direction. That is, inside the waveguide, a standing wave having small light loss in a plane perpendicular to the waveguide is generated, and then proceeds in the waveguide direction. In the case where the diameter of the waveguide aperture is sufficiently larger than the wavelength of the light, a large number of standing waves can be generated inside the waveguide; whereas, when the diameter of the aperture of the waveguide is smaller than the wavelength of the light, standing waves cannot be generated inside the waveguide, so that the light is cut off. This is because the wavelength or the frequency of the lowest-order standing wave generated inside the waveguide is determined in accordance with the shape and diameter of the waveguide aperture.

The following Expression (1) represents a relationship between the waveguide cutoff wavelength λ_{cutoff} and the intra-waveguide wavelength λg for the light energy proceeding through the waveguide. n represents a refractive index of the medium with which the interior part of the waveguide is filled. In addition, the wavelength of the incident light is represented by λ.

$$\begin{matrix}[ Expression 1 ] & \\ \frac{1}{{λ}_{g}^{2}} + \frac{1}{{λ}_{cutoff}^{2}} = \frac{{n}^{2}}{{λ}^{2}} & ( 1 )\end{matrix}$$

According to this relational expression, in the case where the incident light wavelength λ is longer than the cutoff wavelength λ_{cutoff}, the intra-waveguide wavelength λg represents an imaginary number in accordance with the consistency of equations. In terms of physics, this indicates that the light energy is lost and not propagated inside the waveguide.

The cutoff frequency or the cutoff wavelength λ_{cutoff} is dependent on the shape of the waveguide aperture. The standing wave in the direction perpendicular to the waveguide direction can be solved in the same manner as solving a wavelength equation for a film that is shaped identically as the shape of the waveguide aperture, and is represented by Bessel functions.

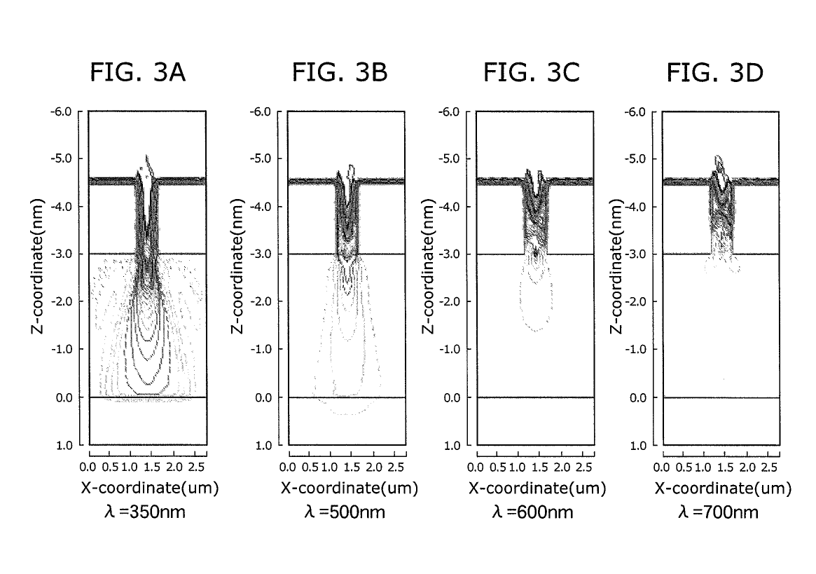

FIGS. 3A to 3D show the result of wave simulation for light propagated on a 500 nm-diameter aperture formed on a metal thin film, performed on lights having wavelengths of 350 nm, 500 nm, 600 nm, and 700 nm. The contours represent electric field intensity. This simulation is for solving Maxwell's equations two-dimensionally and well reproduces the light-blocking effect of the aperture.

FIGS. 3A to 3D show that when light having a wavelength of 350 nm enters through the aperture of 500 nm, the light is transmitted sufficiently through the metal thin film (FIG. 3A). However, as the wavelength becomes longer, less light is transmitted through the metal thin film (FIGS. 3B to 3D). As a result, it can be seen that the metal thin film behaves as a frequency high-pass filter which allows the transmission of only light having a wavelength shorter than a specific wavelength, that is, the cutoff wavelength λ_{cutoff}.

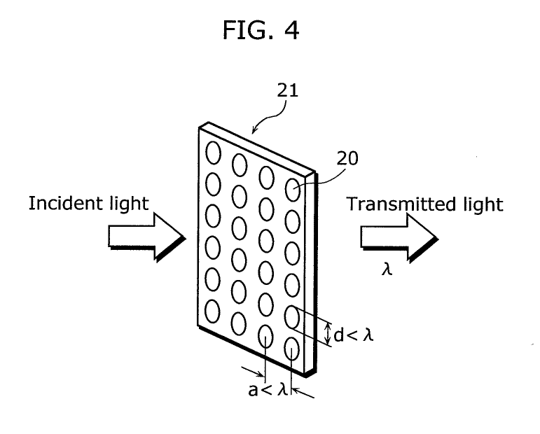

Next, the behavior of light with respect to plural apertures that are periodically arrayed shall be described. FIG. 4 shows a diagram of the metal thin film 21 on which apertures 20 of diameter d are arrayed in a two-dimensional state at an inter-aperture distance (period) a. Note that the inter-aperture distance a is the distance between the center of a predetermined aperture 20 and the center of another aperture 20 adjacent to the predetermined aperture 20. The aperture 20 adjacent to the predetermined aperture 20 is an aperture 20 located at the nearest distance from the predetermined aperture 20.

According to the waveguide model described earlier, the light having a wavelength longer than the cutoff wavelength λ_{cutoff} defined by diameter d is reflected without being transmitted through the metal thin film 21. However, “T. W. Ebbesen, H. J. Lezec, H. F. Ghaemi, T. Thio, and P. A. Wolff, Nature Vol. 391, 667 (1998),” reports the phenomenon in which even the light having a wavelength longer than the cutoff wavelength λ_{cutoff} is transmitted through the metal thin film 21, in the case where the inter-aperture distance a is nearly equal to the incident light wavelength λ or shorter than the incident light wavelength λ. The phenomenon of light transmission is described as the phenomenon in which surface plasmons, excited on the top surface of the metal thin film 21 that is microfabricated in the wavelength size, are propagated through the metal thin film 21, and light having the same frequency as the incident light is emitted from the rear surface. In addition, such a phenomenon in which the light having a wavelength longer than the cutoff wavelength λ_{cutoff} is transmitted through the metal thin film 21 is referred to as abnormal transmission.

In abnormal transmission of light, the surface plasmon excitation plays an important role. Normally, when the flat metal thin film 21 is irradiated with light, no plasmon excitation occurs, and the light is totally reflected. However, in the case where apertures 20, having a nearly equal or smaller size as compared to the wavelength of the light irradiated over the top surface of the metal thin film 21, are periodically arrayed in a two-dimensional state on the top surface of the metal thin film 21, the periodicity due to the apertures 20 is integrated into the dispersion relationship of the surface plasmons, allowing the surface plasmons to be excited by the light. Inside the metal sandwiched between the apertures 20, electrons vibrate due to the electric field of light, and electrons in the neighboring metal across the apertures 20 vibrate in the same manner. The electron vibration starts coupling over the entire surface and collective exciters are generated. At this time, the surface plasmon frequency in abnormal transmission of light is dependent on the periodicity of the apertures 20, and the permittivity or the refractive index of the dielectric material having contact with the top surface of the metal thin film 21 and the apertures 20.

The following Expression (2) represents a relationship between the wavenumber vector k₀ of the incident light, an incidence angle e₀ thereof, and the wavenumber vector kₛₚ of the surface plasmons excited by the incident light. Here, as mentioned earlier, the surface-plasmon wavenumber vector kₛₚ can be related to the inter-aperture distance a and the wavenumber vector k₀. In addition, the following Expression (3) represents a relationship between the surface plasmon wavelength λₛₚ, the permittivity (∈ₘ, ∈ᵢ) of the metal thin film 21 and the dielectric material adjacent to the metal thin film 21, and the inter-aperture distance a. Here, i and j are arbitrary integer numbers, the permittivity of the metal thin film 21 is ∈ₘ, and the permittivity of the dielectric material is ∈ᵢ. In addition, according to the report by Ebbesen (Nature, Vol 391, 667, 1998) et al., when the relationship between the inter-aperture distance a, the relative permittivity ∈ᵣ of a substrate, and the incident light wavelength λ satisfies the condition as shown in the following Expression (4), a node at which the light transmission decreases appears, and when the incident light wavelength λ is longer than that when the condition shown in Expression (4) is satisfied, transmission intensity increases.

$$\begin{matrix}[ Expression 2 ] & \\ \vec{{k}_{sp}} = \vec{{k}_{0}} sin {θ}_{0} \pm i \frac{2 π}{P} \vec{{u}_{x}} \pm j \frac{2 π}{P} \vec{{u}_{y}} & ( 2 ) \\ [ Expression 3 ] & \\ {λ}_{sp} ( i , j ) = \frac{P}{\sqrt{{i}^{2} + {j}^{2}}} {( \frac{{ɛ}_{m} {ɛ}_{i}}{{ɛ}_{m} + {ɛ}_{i}} )}^{1 / 2} & ( 3 ) \\ [ Expression 4 ] & \\ λ = {a}_{0} ɛ {r}^{1 / 2} & ( 4 )\end{matrix}$$

Thus, periodically arraying the plural apertures 20 in the metal thin film 21 allows only the light having a specific wavelength to be transmitted through the metal thin film 21, and enables the metal thin film 21 to function as an optical filter due to the effect of both the waveguide model and the abnormal transmission of light via surface plasmon excitation. In this metal thin film 21, the transmission range of light is on a longer-wavelength side as compared with the cutoff wavelength λ_{cutoff}, and only the light having the surface plasmon wavelength λₛₚ corresponding to the surface plasmon excitation frequency is transmitted. The metal thin film 21 functions as an optical filter in all ranges of wavelengths with wavelengths longer than ultraviolet rays, including visible light range, near-infrared range, and microwave range.

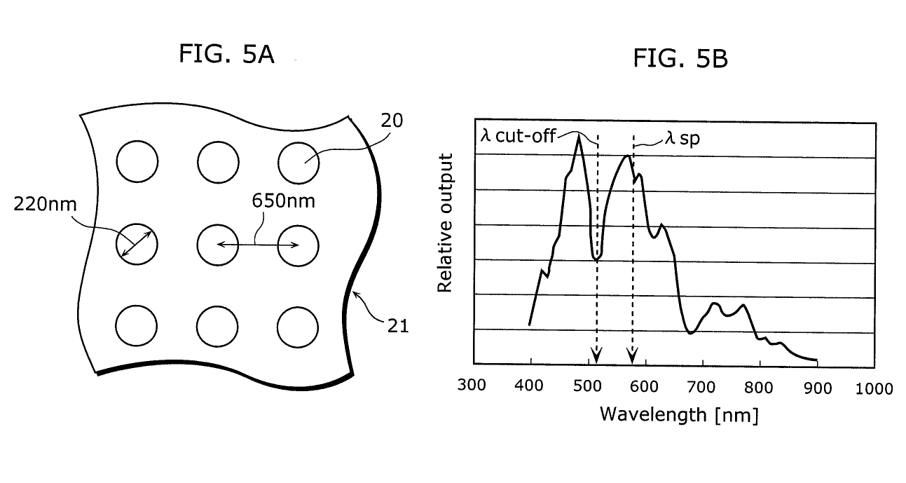

For example, as shown in FIG. 5A, in the metal thin film 21 in which apertures 20 of 220 nm in diameter are periodically formed at an inter-aperture distance of 650 nm, a spectral sensitivity spectrum as shown in FIG. 5B is obtained. That is, a cutoff wavelength λ_{cutoff} of 510 nm and a surface plasmon wavelength λₛₚ of 580 nm are obtained.

Therefore, since an optical color filter can be realized with at least one sheet of metal thin film only, the number of processes for manufacturing color filters is decreased, and a color filter which allows the shortening of manufacturing time and the reduction of manufacturing costs can be realized. In addition, since no color-tone changing occurs, unlike in the conventional pigment-type color filter, a filter having high durability can be realized. Furthermore, since the film can be made thinner and a color filter responsive to scaling down of pixels can be realized, it is possible to realize high-definition of images.

### Second Embodiment

The solid-state imaging device according to the present embodiment is different from the solid-state imaging device in the first embodiment in that photodiodes are arrayed in a two-dimensional state and that a metal optical filter is provided in a two-dimensional state corresponding to each of the photodiodes. Specifically, the solid-state imaging device according to this embodiment is different in that a photodiode is provided with respect to each pixel which is the smallest unit constituting an image that is taken, that a metal optical filter is formed above each photodiode, and that an aperture is provided in the upper part of the pixel on a pixel-to-pixel basis.

By providing a metal optical filter above a photodiode for each pixel, it is possible to design spectral properties for the metal optical filter so that a different color signal can be obtained with each pixel. In a solid-state imaging device, such as a CCD solid-state imaging device and a MOS solid-state imaging device, light is shielded using a metal thin film or the like so as to prevent the light from entering into areas other than the area of the photodiodes, since irradiation of light over the areas other than the area of photodiodes causes the occurrence of false signals and noise. Therefore, by forming, in the imaging area, apertures only in a light path that allows the light to reach a light-receiving area in which photodiodes and so on are formed, and having a metal light-shielding film instead of forming apertures in the other areas, it is possible to realize a color filter equipped with a function of a light-shielding film to prevent false signals and noise and a function of an optical filter at the same time.

In addition, since the transmission range of light that is determined by the surface plasmon wavelength λₛₚ and the waveguide wavelength λ_{cutoff} can be made to differ according to each pixel, a different color signal can be obtained from each pixel. Therefore, since an optical filter can be realized with at least one sheet of metal thin film only, the number of processes for manufacturing color filters is decreased, and a color filter which allows the shortening of manufacturing time and the reduction of manufacturing costs can be realized.

### Third Embodiment

The solid-state imaging device according to the third embodiment of the present invention is different from the solid-state imaging device in the first or the second embodiment in that apertures are cylinder-shaped.

As described earlier, the waveguide cutoff wavelength λ_{cutoff} changes according to the shape of its aperture. In addition, the intra-waveguide wavelength λ_{g} differs in accordance with the polarization of light which enters through the aperture. Therefore, it is possible to prevent the cutoff wavelength λ_{cutoff} or the intra-waveguide wavelength λ_{g} from being dependent on the polarization direction by forming the apertures in a cylindrical or a column-like shape and making the cross-sectional structure of the apertures into a circular shape. As a result, an optical filter which has an equivalent filter function for every polarization direction can be realized.

In addition, the solid-state imaging device according to this embodiment is different from the solid-state imaging device in the first or the second embodiment in that the apertures are arrayed in a staggered state.

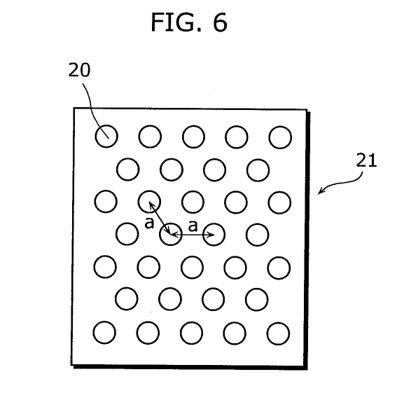

FIG. 6 is a top view showing a metal optical filter. According to FIG. 6, the apertures 20 that are circular and of an identical diameter are arrayed in a staggered state, and, with an aperture 20 as a center, six apertures 20 having an identical inter-aperture distance a to the aperture 20 are arrayed so as to surround the aperture 20. According to the relationship between the incident-light wavenumber vector k₀ in terms of surface plasmon resonance and the surface-plasmon wavenumber vector kₛₚ, the abnormal transmission of light is dependent on the polarization of the light entering through a metal thin film 21 and the inter-aperture distance a. In order to form a metal optical filter that has the least dependency on polarization, the apertures 20 should be arrayed such that the dependency on the polarization direction is at its lowest. In the staggered array, since the apertures 20 can be arrayed most densely, and the periodicity in six directions are equivalent, an excellent optical filter having low polarization dependency can be realized.

### Fourth Embodiment

The solid-state imaging device according to the present embodiment is different from the solid-state imaging devices in the first to the third embodiments in that the top surface of the metal thin film is coated with insulation material and that the interior of each aperture is coated or filled with dielectric material.

As shown by Expression (3), the wavelength for abnormally transmitted light, which is also the surface plasmon wavelength λₛₚ, is determined not only by the inter-aperture distance a or the shape or size of the aperture but also by the properties specific to the material for the metal thin film and the permittivity of the material having contact with the metal thin film. According to Expression (3), it can be seen that as the permittivity of the dielectric material having contact with the metal thin film becomes higher, the surface plasmon wavelength becomes longer. In other words, in the excitation of surface plasmons of a specific frequency, compared to a material with low permittivity, the higher the permittivity of the dielectric material having contact with the metal, the greater the inter-aperture distance becomes. As a result, in a wavelength band within which a photodiode is sensitive, the miniaturization of the inter-aperture distance a becomes unnecessary through the depositing of dielectric material showing large permittivity onto the surface of the metal thin film and the filling of the interior of the aperture with the dielectric material. At the same time, even when the miniaturization of the aperture is performed in the same manner, the forming of dielectric material extends the range of abnormal transmission to shorter wavelengths, allowing, as a result, the functioning as an optical filter in a wider range of wavelengths.

In addition, in order to improve transmission efficiency, it is preferable that the interior of each aperture is filled with dielectric material showing high permittivity. When light is transmitted through the metal thin film, dielectric flux lines due to an electric field generated from light transmission have a property of converging on the dielectric material. Since metal has a property of repelling dielectric flux lines due to negative dielectric response, the dielectric flux density within the dielectric material increases as the permittivity of the dielectric material having contact with the metal thin film is higher. Accordingly, it is possible to realize an optical filter having high transmissivity by coating the surface of the metal thin film with dielectric material having high permittivity and filling the interior of the aperture with the material.

### Fifth Embodiment

The solid-state imaging device according to the present embodiment is different from the solid-state imaging devices in the first to the fourth embodiments in that plural apertures are periodically arrayed in a two-dimensional state and the inter-aperture distance is equal to or less than the wavelength of the light transmitted through the metal optical filter. In addition, the size of each aperture is smaller than the wavelength of the light transmitted through the metal optical filter, and that the aperture size and the inter-aperture distance are specified in accordance with the wavelength of the light transmitted through the metal optical filter.

As seen from Expressions (2) to (4), since the wavelength of light that is abnormally transmitted due to surface plasmon resonance is determined by the inter-aperture distance a, when allowing transmission of light of a desired wavelength, the inter-aperture distance a should be made equal to or shorter than the desired wavelength. When the inter-aperture distance a is longer than the desired wavelength, the metal thin film exhibits the same optical behavior with respect to the light as a metal thin film having a flat surface. That is, the phenomenon of abnormal transmission is no longer shown, and a microwave is fully reflected as with a normal metal thin film. Therefore, in order to allow the metal optical filter to function as an optical filter, the inter-aperture distance a should be made smaller than the light transmitted through the metal optical filter.

Next, the aperture size shall be described. As described earlier, since the aperture size determines the cutoff frequency, the aperture size should be made smaller than the desired wavelength in transmitting the light of a desired wavelength. An imaging device covering the visible light range should have an aperture size smaller than the visible light that is the transmitted wavelength. Therefore, in order to enable the metal optical filter to function as an optical filter, the aperture size should be made smaller than the wavelength of the light transmitted through the metal optical filter.

Hereinafter, a solid-state imaging device which captures images in the visible light range shall be described as an example.

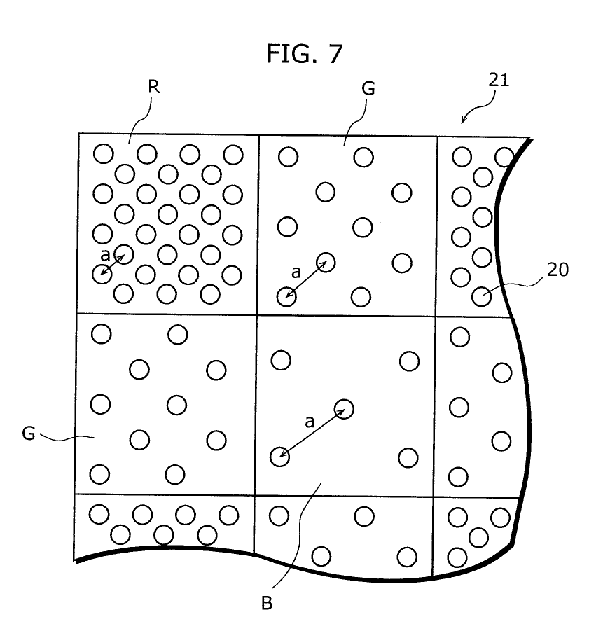

In a CCD solid-state imaging device and a MOS solid-state imaging device, incident light is absorbed, dispersed, and transmitted through on-chip color filters. As a result, lights of the three wavelength bands of the three primary colors of light, that is, red (R), green (G), and blue (B) are obtained. The solid-state imaging device performs image composition using color signals obtained from the light transmitted through these color filters. Here, assuming that the wavelength indicating the maximal transmissivity for each of the three primary colors of light R, G, and B is 480 nm, 530 nm, and 650 nm, respectively, in order that the transmission of light can be observed in the case where the incident light wavelength λ is longer than the incident light wavelength λ satisfying the condition in Expression (4), the inter-aperture distance a for the apertures formed in the upper part of each pixel should be 480 nm or less, 530 nm or less, and 650 nm or less for R, G, and B, respectively. Therefore, in this case, as shown in a top view of the color filter in FIG. 7, metal optical filters having different inter-aperture distances a are arrayed for: a pixel for performing photoelectric conversion on R, a pixel for performing photoelectric conversion on G, and a pixel for performing photoelectric conversion on B, respectively. When a circular waveguide is adopted for the aperture, the aperture size should be 300 nm or less.

### Sixth Embodiment

The solid-state imaging device according to the present embodiment is different from the solid-state imaging devices in the first to the fifth embodiments in that the metal thin film is made of Ag, Pt, or Au.

The type of metal material of which the metal optical filter is made not only serves as a factor that determines the wavelength of transmitted light but also largely affects the transmissivity of abnormally-transmitted light. In terms of the dielectric properties of the material, one of major factors in determining light transmissivity is an imaginary part of complex permittivity. By definition, permittivity is a coefficient that gives dielectric flux density response upon the application of an alternating electric field.

A component having an in-phase response to the electric field of the dielectric flux is expressed in a real part, and a component having a phase lag is expressed in the imaginary part. When the imaginary part is present, the real part is generated in the impedance, and absorption, heating, and the like, occur. As a result, thermal loss of energy is caused by the generation of impedance with respect to the electrons moving due to the changes in the electric field of light that undergoes coupling with surface plasmons. This means a decrease in transmissivity. Thus, for realizing an optical filter with a high transmission property, the imaginary part for complex permittivity needs to be as small as possible. Ag, Pt, or Au has a smaller imaginary part for complex permittivity as compared with other metals, and thus make it possible to realize an optical filter with excellent transmission property.

### Seventh Embodiment

The solid-state imaging device according to the present embodiment is different from the solid-state imaging devices in the first to the sixth embodiments in that a metal optical filter is formed on a planarized dielectric film formed between a photodiode and a metal optical filter. In addition, the device is also different from the solid-state imaging devices in the first to the six embodiments in that the metal thin film is made of the same material as the material for metal wiring. Furthermore, the device is different from the solid-state imaging devices from the first to the six embodiments in that the metal optical filter is formed in the same process as the process for forming the metal wiring.

Here, the process of manufacturing a solid-state imaging device equipped with the metal optical filter shall be described. In either of a CCD and a MOS solid-state imaging devices, forming of the metal optical filter in a silicon process is required in order to achieve low-cost manufacturing.

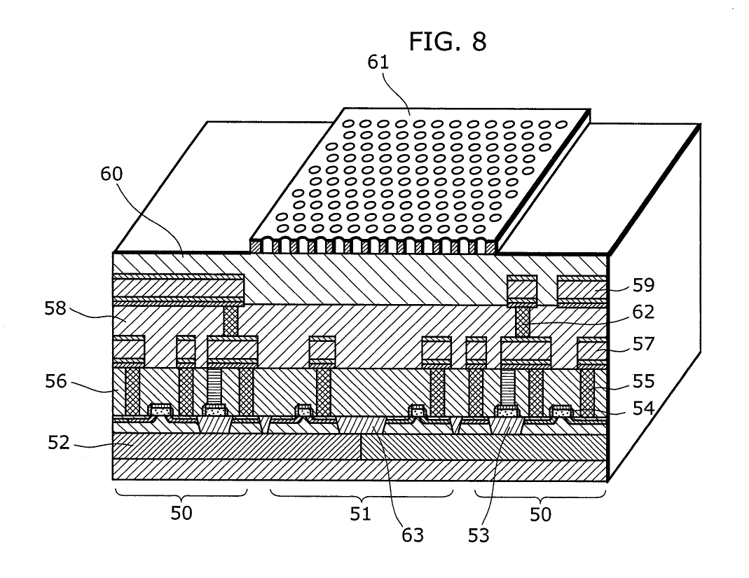

FIG. 8 shows a perspective view for illustrating the process for forming the metal optical filter. Here, a solid-state imaging device using a two-layer aluminum wiring is described as an example.

First, the following are formed in a diffusion region 52 of a semiconductor substrate: an element separation region 53 for electrically separating a pixel unit 51 and a peripheral circuit unit 50; a photodiode 63; and a transistor 54 for obtaining an electric signal from the photodiode 63.

Next, after an interlayer film 56 is formed on the semiconductor substrate, a metal plug 55 connected to the transistor 54 and the photodiode 63 is formed in the interlayer film 56.

Next, after the metal thin film is formed on the interlayer film 56, the metal thin film is patterned by etching, and a first-layer aluminum wiring 57 is formed.

Next, after an interlayer film 58 is formed on the first aluminum wiring 57 and the interlayer film 56, a metal plug 62 connected to the first-layer aluminum wiring 57 is formed in the interlayer film 58.

Next, after the metal thin film is formed on the interlayer film 58, the metal thin film is patterned by etching, and second-layer aluminum wiring 59 is formed.

Next, an insulation film 60 is formed on the second-layer aluminum wiring 59 and the interlayer film 58. In performing this, the insulation film 60 is made sufficiently thick in view of a planarization process.

Next, the process for planarizing the insulation film 60 is performed. An Etch Back process, Chemical Mechanical Polishing (CMP), and the like, are commonly used for planarization. To improve on unevenness in flatness, CMP is often performed on the insulation film 60 after reducing, by etching, a raised portion of the insulation film 60 under which the aluminum wiring is directly placed using a negative/positive inversion mask with respect to a patterning mask for forming the second-layer aluminum wiring 59.

Finally, a metal optical filter 61 is formed on a portion, in the insulation film 60, located above the photodiode 63. The forming of the metal optical filter 61 necessitates microfabrication in dimensions smaller than the wavelength of light that is detectable by a photodetector such as the photodiode 63. However, when lithography is performed in the condition where unevenness is present, lithography precision which enables microfabrication cannot be achieved. However, with the introduction of the planarization process, it becomes possible to manufacture, using lithography, a metal optical filter that is sufficiently microfabricated.

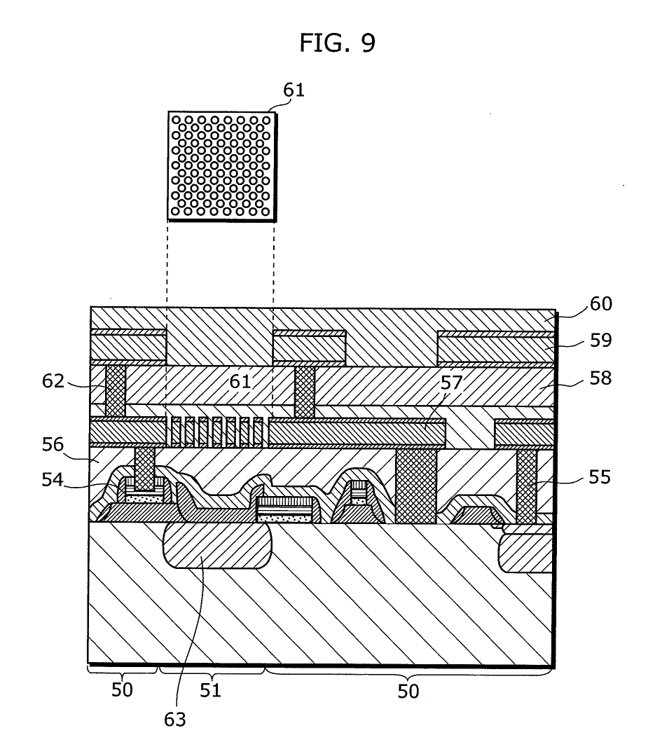

Here, as shown in FIG. 9, when the metal optical filter 61 is made of the same material as the material for the first-layer aluminum wiring 57 and formed by using part of the first-layer aluminum wiring 57, the patterning for forming the first-layer aluminum wiring 57 and the patterning for forming the metal optical filter 61 can be performed with the same mask, and thus the planarization process becomes unnecessary.

In this case: the metal thin film is formed on the interlayer film 56; the metal thin film is patterned; and the metal optical filter 61 located above the photodiode 63 and the first-layer aluminum wiring 57 located in the other part are formed in the same process (the same layer). Then, the interlayer film 58 is formed on the first-layer aluminum wiring 57, the metal optical filter 61, and the interlayer film 56, and then the second-layer aluminum wiring 59 is formed on the interlayer film 58. Since microfabrication is also performed in forming the second-layer aluminum wiring 59, the interlayer film 58 located above the first-layer aluminum wiring 57 and the metal optical filter 61 is planarized. Therefore, in forming the metal optical filter 61, it is sufficient to lay out a pattern necessary for the metal optical filter 61 onto the pixel portion of the same mask as the pattern of the second-layer aluminum wiring 59. Subsequently, by performing lithography on the metal thin film, and then carrying out the same patterning, it is possible to introduce color filters without increasing the number of processes.

Note that although, in this embodiment, aluminum wiring is shown as an example of the metal wiring, the metal wiring is not limited to this, and tungsten wiring, for example, is also acceptable.

### Eighth Embodiment

The solid-state imaging device according to the present embodiment is different from the solid-state imaging devices in the first to the seventh embodiments in that the apertures in a metal optical filter are rectangular through-grooves (slits) in which a long side of each slit is longer than the wavelength of light transmitted through the metal optical filter, and that a short side of the slit is shorter than the wavelength transmitted through the metal optical filter.

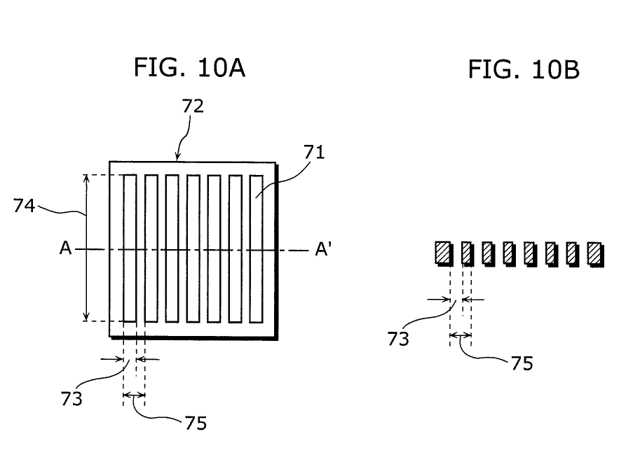

FIG. 10A shows a top view of the metal optical filter having slits. In addition, FIG. 10B shows a cross-sectional view of the metal optical filter.

Slits 71 are formed in the metal thin film 72 by etching. A shorter side of each of the slits 71 is a silt short side 73, and a longer side is a slit long side 74. The space between two neighboring slits 71 is an inter-slit distance 75. In this manner, by providing, above each pixel, a metal thin film 72 having a slit structure, polarized light parallel to the long-side direction of the slit (slit direction) is reflected, and polarized light perpendicular to the slit direction is transmitted, thus allowing each pixel to separate and receive the polarized light. In the case where the slit short side 73 is longer than the incident light wavelength λ, since polarized components parallel to the slit direction are transmitted, only light having a longer wavelength than the cutoff wavelength λ_{cutoff} in the slit direction is reflected. Therefore, in order to enable the metal optical filter to function as a polarization filter, the slit short side 73 should be shorter than a desired cutoff wavelength λ_{cutoff}, and the slit long side 74 should be longer than the desired cutoff wavelength λ_{cutoff}. In a range of wavelengths longer than the cutoff wavelength λ_{cutoff}, the polarized light parallel to the slit direction is cut off, and the polarized light perpendicular to the slit direction is transmitted. Thus, the metal optical filter functions as a polarization element on a longer-wavelength side than the cutoff wavelength determined by the slit structure. Since the slits 71 in the metal optical filter used for a solid-state imaging device is required to have a sufficient capacity for polarization separation even within a visible light range, the inter-slit distance 75 and the slit short side 73 need to be sufficiently smaller than the wavelength band of the visible light. For example, it is preferable that the inter-slit distance 75 and the slit short side 73 is 200 nm or less.

### Ninth Embodiment

The solid-state imaging device according to the present embodiment is different from the solid-state imaging devices in the first to the eighth embodiments in that: a metal optical filter is made up of at least two metal thin films formed above a photodiode with an insulation film sandwiched in between; each of the metal thin films has slits that are periodically provided as apertures; the long-side direction of each of the slits provided in a first metal thin film and a long-side direction of each of the slits provided in a second metal thin film are placed at 90 degrees to each other; and that the first metal thin film and the second metal thin film are formed on each pixel, with an insulation film, which is transparent with respect to transmitted light, being sandwiched in between.

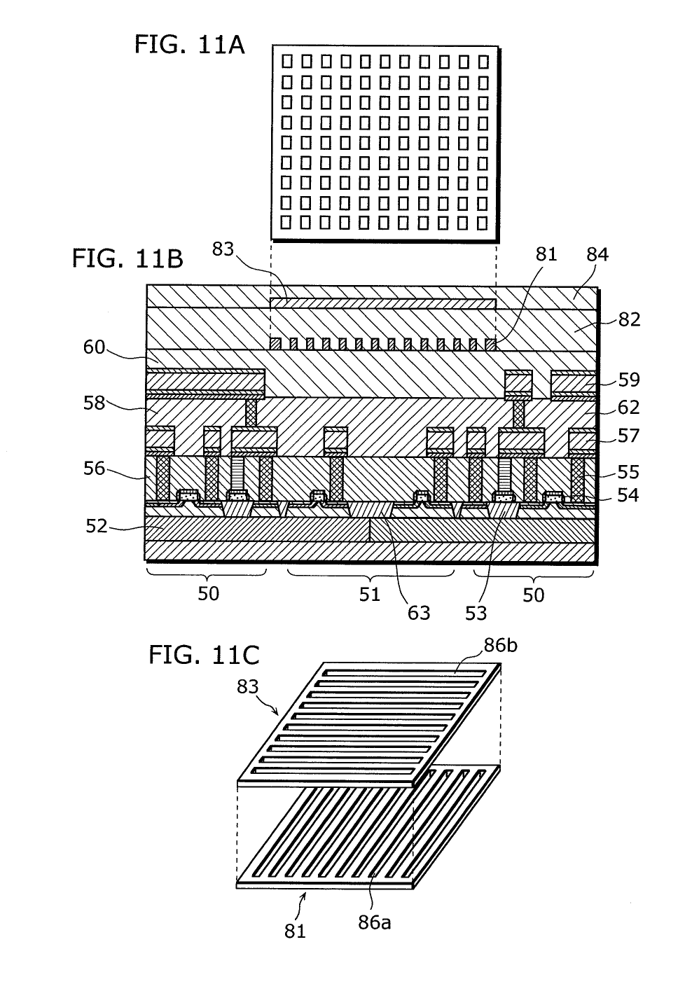

FIG. 11A shows a top view of the metal optical filter. FIG. 11B shows a cross-sectional view of the solid-state imaging device. FIG. 11C shows a perspective view of a first-layer (lower-layer) metal thin film 81 and a second-layer (upper-layer) metal thin film 83 which make up the metal optical filter.

In the process for forming the metal optical filter, the first-layer metal thin film 81 is formed first, and an insulation film 82 is formed after slits 86a are formed by etching in the first-layer metal thin film 81. Following this, planarization, such as CMP and etch back, is performed on the insulation film 82 for forming the second-layer metal thin film 83. Then, the second-layer metal thin film 83 is formed on the insulation film 82 that is flat and transparent with respect to transmitted light, slits 86b are formed by etching in the second-layer metal thin film 83, and an insulation film 84 is formed.

In the metal optical filter, the slit directions of the first-layer metal thin film 81 and the second-layer metal thin film 83 are in vertical relationship, and as the top view in FIG. 11A shows, rectangular apertures are formed in the traveling direction of the light. According to this structure, a wavelength longer than the cutoff wavelength λ_{cutoff} determined by the slits can be cut off and dispersed. Since the slit directions of the first-layer metal thin film 81 and the second-layer metal thin film 83 are in a vertical relationship, the cutoff frequencies for both are identical when the slit widths and the inter-slit distances for the first-layer metal thin film 81 and the second-layer metal thin film 83 are identically designed.

In the metal optical filter, first, the second-layer metal thin film 83 responds to the incident light. Here, light which is parallel to the slit direction is reflected so that transmission is cut off. The light that is transmitted is only the polarized light which is perpendicular to the slit direction of the second-layer metal thin film 83. The polarization direction of the light is parallel to the long-side direction of the slits 86a in the first-layer metal thin film 81. Accordingly, for the light transmitted through the second-layer metal thin film 83, a wavelength longer than the cutoff wavelength λ_{cutoff} is reflected and the transmission is cut off due to the cutoff phenomenon of the first-layer metal thin film 81. With the effect of these two metal thin films, dispersion at an identical cutoff wavelength λ_{cutoff} becomes possible in either polarized light.

At this time, the inter-slit distance between the slits 86a and the slits 86b is set to be equal to or shorter than a desired wavelength so that light of the desired wavelength can be transmitted through abnormal transmission of light due to surface plasmon resonance.

In the case of a metal optical filter using the cutoff effect of a normal circular waveguide, circular apertures should be made by lithography and etching. However, the size of each circular aperture with respect to a short wavelength band is small, at about 200 nm, and there is often inconsistency in terms of process technology in the forming of such small holes, thus leading to a decrease in the yield. However, the slit structure can be formed with good uniformity even in lithography and etching, and it is easy to manufacture minute slits having a width of 200 nm or less. Thus, it is possible to maintain the yield, and further to offer a color filter which excels in color resolution.

### Tenth Embodiment

The solid-state imaging device according to the present embodiment is different from the solid-state imaging devices in the first to the ninth embodiments in that the width of the apertures in the metal optical filter tapers from a plane of the light-entering side of the metal optical filter toward a plane on the photodiode side.

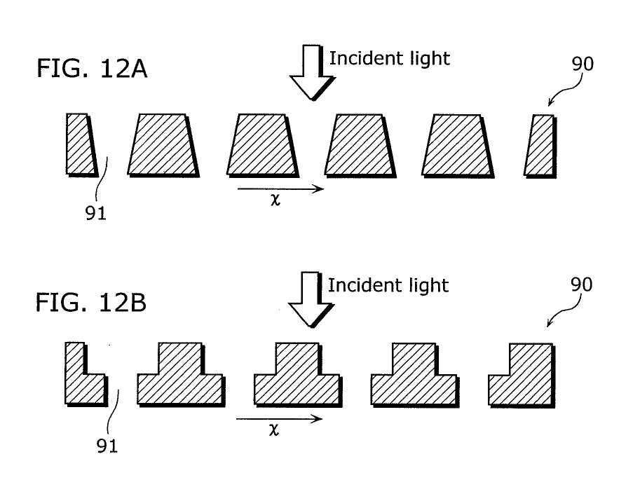

FIG. 12A shows a cross-sectional view of a metal thin film 90 in which apertures 91 are formed.

As shown in FIG. 12A, the diameter (the x-directional width in FIG. 12A) of each of the apertures 91 gradually tapers from the light-entering plane side of the metal thin film 90. Since the cutoff wavelength λ_{cutoff} is determined by the diameter of each of the apertures 91, it is possible to establish plural cutoff wavelengths λ_{cutoff} by forming the apertures 91 in a tapered shape. Basically, since the wavelength of light that is abnormally transmitted due to plasmon resonance is strongly controlled by the inter-aperture distance a, it is possible to expand the range of wavelengths to be cut off by combining the plural cutoff wavelengths λ_{cutoff}.

Note that since the intention is to establish plural cutoff wavelengths, the diameter of the apertures 91 need not change continuously, and as shown in FIG. 12B, the diameter of the apertures 91 may be made smaller in stages, that is, in a stepped pattern.

### Eleventh Embodiment

The solid-state imaging device according to the present embodiment is different from the solid-state imaging devices in the first to the tenth embodiments in that the film thickness of the metal thin film is 1000 nm or less.

Abnormal transmission of light due to plasmon resonance is caused when surface plasmons, excited in the top surface of the metal thin film, start coupling with surface plasmons in the rear surface, and the surface plasmons in the rear surface are also excited in the same manner as in the top surface. Therefore, when the thickness of the metal thin film is large, the electron motion in the top surface does not start coupling with the electron motion in the rear surface, and the light transmissivity due to surface plasmon resonance decreases. Therefore, the metal thin film needs to have a thickness which allows the surface plasmons in the top surface and the rear surface to resonate with each other.

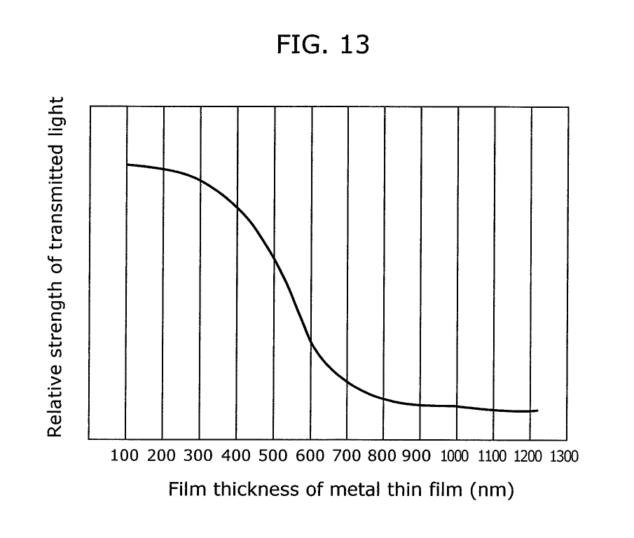

FIG. 13 is a graph showing the relationship between the thickness of the metal thin film and the light transmissivity with respect to the light of 700 nm in length on the long-wavelength side within a range of visible light in which there is luminous efficiency.

As shown in FIG. 13, transmissivity decreases drastically along with an increase in the thickness of the metal thin film. Therefore, in the case where the metal optical filter is applied to an image sensor within a visible light range, the thickness of the metal thin film is required to be 1000 nm or less. In addition, as the film becomes thicker, the length of the aperture becomes larger. This results in attenuation of light due to the impedance in the lateral surface of the aperture, and the transmissivity decreases. However, although dependent on the material of the metal thin film, when the metal thin film is made too thin, light is transmitted due to the transmissivity specific to the material and thus cannot be dispersed. Therefore, it is preferable that the thickness of the metal thin film is 100 nm or more.

### Twelfth Embodiment

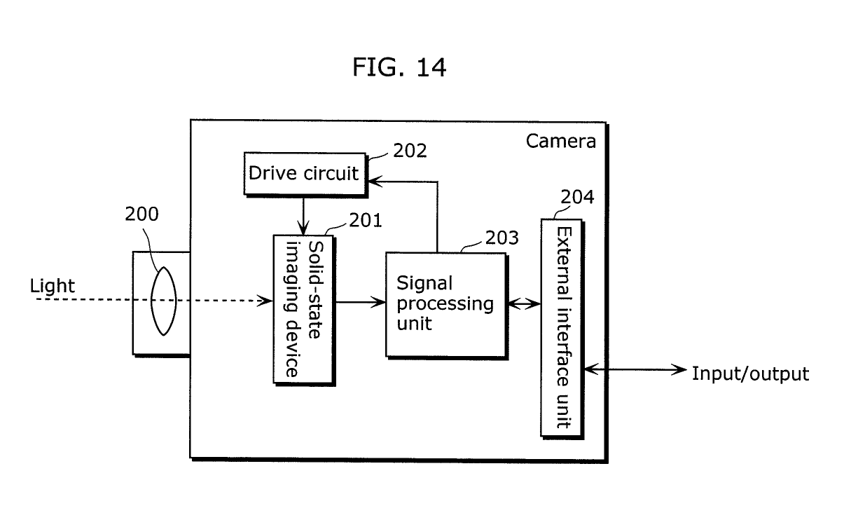

FIG. 14 is a block diagram of a digital camera according to the present embodiment.

This digital camera is a camera using a solid-state imaging device described in the first to the eleventh embodiments, and includes: a lens 200, a solid-state imaging device 201, a drive circuit 202, a signal processing unit 203, and an external interface unit 204.

In the digital camera having the structure, a process until a signal is outputted to the outside is performed according to the procedure as follows.

(1) Light is transmitted through the lens 200 and enters the solid-state imaging device.

(2) The signal processing unit 203 drives the solid-state imaging device 201 through the drive circuit 202, and obtains an output signal from the solid-state imaging device 201.

(3) The signal processed in the signal processing unit 203 is outputted to the outside via the external interface unit 204.

As described above, according to the metal optical filter in the embodiments, it is possible to selectively transmit light having a specific wavelength by abnormal transmission phenomenon due to surface plasmon resonance. In addition, since the optical filter is made of metal thin film, the optical filter can be made thinner and miniaturized, and it is possible to achieve not only high durability while maintaining color resolution, but also a reduction in the number of manufacturing processes and manufacturing time. As a result, it becomes possible to provide a more inexpensive solid-state imaging device and camera, which allow the capturing of high-definition and high-quality images.

Thus far, the solid-state imaging device and the camera according to the present invention have been described in accordance with exemplary embodiments. However, the present invention is not limited to these embodiments. Various modifications conceived and applied by those skilled in the art without departing from the present invention are intended to be included within the scope of the present invention.

### INDUSTRIAL APPLICABILITY

The present invention can be used for a solid-state imaging device, and particularly, for a color filter or the like for the solid-state imaging device.

What is claimed is:

1. A solid-state imaging device, comprising:
a plurality of photodiodes; and
a plurality of metal optical filters each formed above a corresponding one of said plurality of photodiodes, and which allows light of a desired wavelength to be transmitted,
wherein each of said plurality of metal optical filters is made up of a metal film in which plural apertures are periodically arrayed.

2. The solid-state imaging device according to claim 1,
wherein said plurality of photodiodes is arrayed two-dimensionally, and
said plurality of metal optical filters is arrayed two-dimensionally, each corresponding to one of said plurality of photodiodes.

3. The solid-state imaging device according to claim 1,
wherein each of the plural apertures in each of said plurality of metal optical filters is cylinder-shaped.

4. The solid-state imaging device according to claim 1,
wherein the plural apertures in each of said plurality of metal optical filters are arrayed in a staggered state.

5. The solid-state imaging device according to claim 1,
wherein a surface of each of said plurality of metal optical filters is coated with dielectric material, and
an interior of each of the apertures in each of said plurality of metal optical filters is coated or filled with the dielectric material.

6. The solid-state imaging device according to claim 1,
wherein a distance between a predetermined one of the apertures and an aperture adjacent to the predetermined one of the apertures is shorter than the desired wavelength.

7. The solid-state imaging device according to claim 1,
wherein a size of a predetermined one of the apertures is smaller than the desired wavelength, and
a distance between the predetermined one of the apertures and an aperture adjacent to the predetermined one of the apertures is shorter than the desired wavelength.

8. The solid-state imaging device according to claim 1,
wherein the metal film is made of silver (Ag), platinum (Pt), or gold (Au).

9. The solid-state imaging device according to claim 1, further comprising
a dielectric film formed between each of said plurality of photodiodes and a corresponding one of said plurality of metal optical filters, and having a flat surface on which said metal optical filter is formed.

10. The solid-state imaging device according to claim 1, further comprising
a metal wiring made of the same material as a material of which the metal film is made.

11. The solid-state imaging device according to claim 10,
wherein said plurality of metal optical filters is formed in the same process as a process in which the metal wiring is formed.

12. The solid-state imaging device according to claim 1,
wherein a width of each of the apertures tapers, from a surface of each of said plurality of metal optical filters at which light enters, toward a surface of a corresponding one of said plurality of photodiodes.

13. The solid-state imaging device according to claim 1,
wherein a film thickness of the metal film is 1000 nm or less.

14. The solid-state imaging device according to claim 1,
wherein in the metal film, a slit is formed as each of the apertures.

15. The solid-state imaging device according to claim 14,
wherein a long side of the slit is longer than the desired wavelength, and a short side of the slit is shorter than the desired wavelength.

16. The solid-state imaging device according to claim 10,
wherein said plurality of metal optical filters is made up of a first metal film and a second metal film, the plural apertures being periodically arrayed in both the first and second metal films,
in the first metal film and the second metal film, a slit is formed as each of the plural apertures, and
an angle formed by a long-side direction of the slit in the first metal film and a long-side direction of the slit in the second metal film is 90 degrees.

17. The solid-state imaging device according to claim 2,
wherein a distance between a predetermined one of the apertures and an aperture adjacent to the predetermined one of the apertures differs according to each of said plurality of metal optical filters.

18. A camera equipped with the solid-state imaging device according to claim 1.
